(19) United States
(12) Patent Application Publication
(10) Pub. No.: US 2024/0259962 A1
(43) Pub. Date: Aug. 1, 2024

(54) AUTOMATIC GAIN CONTROL TRAINING FOR SIDELINK COMMUNICATIONS

(71) Applicant: QUALCOMM Incorporated, San Diego, CA (US)

(72) Inventors: Chih-Hao LIU, San Diego, CA (US); Jing SUN, San Diego, CA (US); Giovanni CHISCI, San Diego, CA (US); Xiaoxia ZHANG, San Diego, CA (US); Zhifei FAN, San Diego, CA (US)

(21) Appl. No.: 18/452,982

(22) Filed: Aug. 21, 2023

Related U.S. Application Data
(60) Provisional application No. 63/482,506, filed on Jan. 31, 2023.

(51) Int. Cl. H04W 52/52; H04W 52/38; H04W 52/42

(52) U.S. Cl. CPC H04W 52/52; H04W 52/383; H04W 52/42

(57) ABSTRACT

Various aspects of the present disclosure generally relate to wireless communication. In some aspects, a transmitter wireless communication device may transmit a plurality of automatic gain control (AGC) symbols associated with one or more sidelink communications. The transmitter wireless communication device may transmit the one or more sidelink communications after transmitting the plurality of AGC symbols. Numerous other aspects are described.

### CROSS-REFERENCE TO RELATED APPLICATION

This Patent application claims priority to U.S. Provisional Patent Application No. 63/482,506, filed on Jan. 31, 2023, entitled “AUTOMATIC GAIN CONTROL TRAINING FOR SIDELINK COMMUNICATIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for automatic gain control (AGC) training for sidelink communications.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a transmitter wireless communication device. The method includes transmitting a plurality of automatic gain control (AGC) symbols associated with one or more sidelink communications; and transmitting the one or more sidelink communications after transmitting the plurality of AGC symbols. Another aspect provides an apparatus configured for wireless communications. The apparatus may include one or more memories and one or more processors comprising processor-executable instructions. The one or more processors may be configured to execute the processor executable instruction and cause the apparatus to transmit a plurality of AGC symbols associated with one or more sidelink communications. The one or more processors may be configured to execute the processor executable instruction and cause the apparatus to transmit the one or more sidelink communications after transmitting the plurality of AGC symbols.

Another aspect provides a method for wireless communication by a receiver wireless communication device. The method includes determining a beam-specific AGC setting for a receive beam associated with reception of sidelink communications on a sidelink between the receiver wireless communication device and a transmitter wireless communication device; and storing an indication of the beam-specific AGC setting for the receive beam. Another aspect provides an apparatus for wireless communication. The apparatus may include one or more memories and one or more processors comprising processor-executable instructions. The one or more processors may be configured to execute the processor executable instruction and cause the apparatus to determine a beam-specific automatic gain control (AGC) setting for a receive beam associated with reception of sidelink communications on a sidelink between the apparatus and a transmitter wireless communication device. The one or more processors may be configured to execute the processor executable instruction and cause the apparatus to store an indication of the beam-specific AGC setting for the receive beam.

Other aspects provide: an apparatus operable, configured, or otherwise adapted to perform any one or more of the aforementioned methods and/or those described herein with reference to and as illustrated by the drawings and specification; a non-transitory, computer-readable medium comprising computer-executable instructions that, when executed by a processor of an apparatus, cause the apparatus to perform the aforementioned methods and/or those described herein with reference to and as illustrated by the drawings and specification; a computer program product embodied on a computer-readable storage medium comprising code for performing the aforementioned methods and/or those described herein with reference to and as illustrated by the drawings and specification; and/or an apparatus comprising means for performing the aforementioned methods and/or those described herein with reference to and as illustrated by the drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example network node and a user equipment (UE), in accordance with the present disclosure.

FIGS. 3A, 3B, 3C, and 3D depict aspects of data structures for a wireless communications network, such as wireless communications network of FIG. 1, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIGS. 6A-6C are diagrams illustrating examples associated with automatic gain control (AGC) training for sidelink communications, in accordance with the present disclosure.

FIG. 7 is a diagram illustrating an example associated with AGC training for sidelink communications, in accordance with the present disclosure.

FIG. 8 shows a method for wireless communications by a transmitter wireless communication device, in accordance with the present disclosure.

FIG. 9 shows a method for wireless communications by a receiver wireless communication device, in accordance with the present disclosure.

FIG. 10 is a diagram illustrating an example of an implementation of code and circuitry for a communications device, in accordance with the present disclosure.

FIG. 11 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for automatic gain control (AGC) training for sidelink communications.

A receiver wireless communication device may perform automatic gain control (AGC) training in association with performing AGC. Generally, AGC training is performed because the receiver wireless communication device needs to tune one or more receive chain components (e.g., a power amplifier (PA)) for reception of a given sidelink communication in order to properly set the gain based on the receive signal strength. An AGC settling time is an amount of time needed for the radio frequency (RF) front end to perform a measurement and achieve convergence on the AGC loop so that an estimated gain for the one or more receive chain components is within a desired accuracy. Notably, when the receiver wireless communication device does not perform AGC training before attempting to receive a sidelink communication or takes too long to perform AGC training, one or more symbols of the sidelink communication may not be received correctly, potentially leading to loss of sidelink data. Some wireless communication devices may be configured for sidelink communication in a higher frequency range, such as in a frequency band within frequency range 2 (FR2) (e.g., FR2-2). For sidelink communications in such higher frequency ranges, some wireless communication devices may be configured to utilize a higher subcarrier spacing (SCS), such as 120 kilohertz (kHz), 480 kHz, 960 kHz, or the like. However, a sampling rate stays relatively constant regardless of numerology employed. Thus, the same sampling rate may be used across different numerologies (e.g., even at higher SCSs), which means that an AGC settling time is constrained by the sampling rate. As a result, a quantity of symbols needed for AGC training increases with SCS.

A waveform for the multiple AGC symbols needs to be defined to support AGC training for sidelink communications in such higher frequency ranges as FR2-2. Further, an amount of overhead increases as the number of AGC symbols increases, which lowers throughput of sidelink communications. Therefore, it is desirable to reduce overhead associated with AGC symbol transmission, while maintaining support for AGC training for sidelink communications in higher frequency ranges.

Some aspects described herein provide techniques and apparatuses for AGC training for sidelink communications (e.g., sidelink communications in a higher frequency range, such as FR2-2). In some aspects, a transmitter wireless communication device may transmit a plurality of AGC symbols associated with one or more sidelink communications, and may then transmit the one or more sidelink communications after transmitting the plurality of AGC symbols. In some aspects, the techniques and apparatuses described herein define a waveform for AGC symbols to be used for AGC training for sidelink communications and reduce overhead associated with transmission of the AGC symbols, thereby enabling reliable AGC training and increasing sidelink throughput.

For example, in some aspects, the plurality of AGC symbols includes a repetition of one or more symbols of the one or more sidelink communications. In some aspects, repetition of one or more symbols of the one or more sidelink communications does not increase complexity and consumption of resources (e.g., battery power, processor resources) in association with transmitting the plurality of AGC symbols.

In some aspects, the plurality of AGC symbols includes a plurality of randomly generated symbols. In some aspects, the use of a plurality of randomly generated symbols enables transmission of the plurality of AGC symbols irrespective of timing of generation of symbols of the one or more sidelink communications.

In some aspects, the plurality of AGC symbols includes a repetition of a demodulation reference signal (DMRS) associated with the one or more sidelink communications. In some aspects, the use of the DMRS enables transmission of the plurality of AGC symbols irrespective of timing of generation of symbols of the one or more sidelink communications.

In some aspects, the one or more sidelink communications are transmitted in a plurality of contiguous slots (e.g., in a “super-slot) and the plurality of AGC symbols are transmitted in one or more slots immediately prior to the plurality of contiguous slots. In such an aspect, the plurality of AGC symbols can be utilized in association with performing AGC for each of the one or more sidelink communications in the plurality of contiguous slots (e.g., rather than for a single sidelink communication in a single slot). In this way, AGC overhead is reduced, thereby increasing throughput for sidelink communications.

Further, in some aspects, a receiver wireless communication device may determine and store a beam-specific AGC setting for a receive beam associated with reception of sidelink communications on a sidelink between the receiver wireless communication device and a transmitter wireless communication device. The receiver wireless communication device may then perform AGC for a sidelink communication received using the receive beam based at least in part on the beam-specific AGC setting. In some aspects, use of the stored beam-specific AGC setting may enable AGC for multiple sidelink communications using the receive beam without a need to repeat AGC training, thereby reducing AGC overhead and increasing throughput for sidelink communications.

Various aspects of the disclosure are described more fully hereinafter with reference to the accompanying drawings. This disclosure may however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

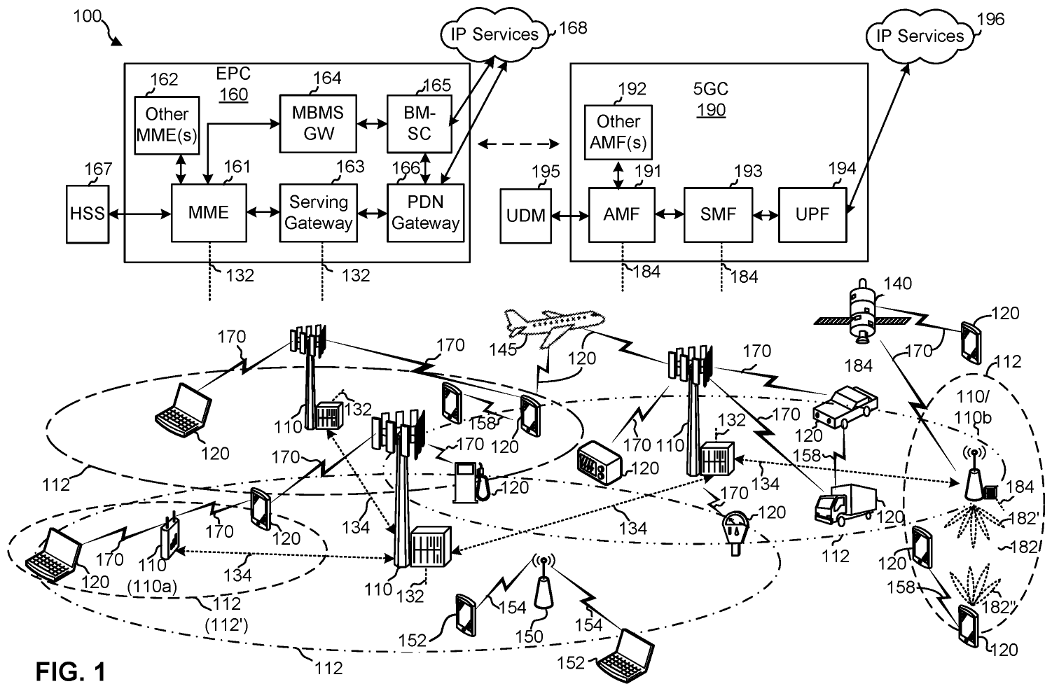

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 (also referred to as network nodes 110) may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

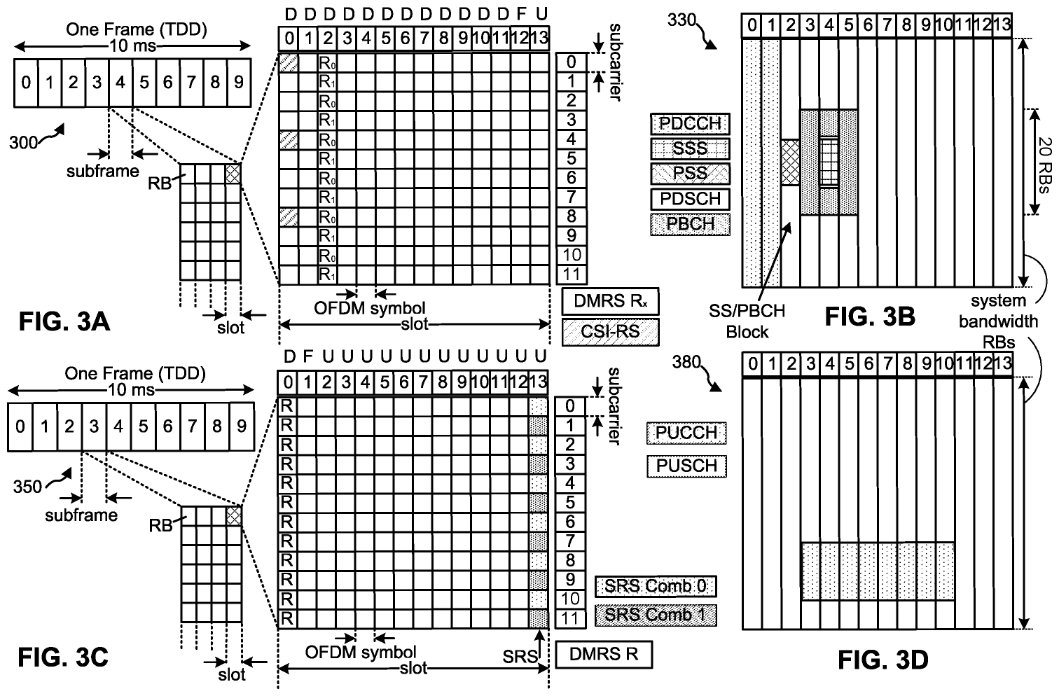

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

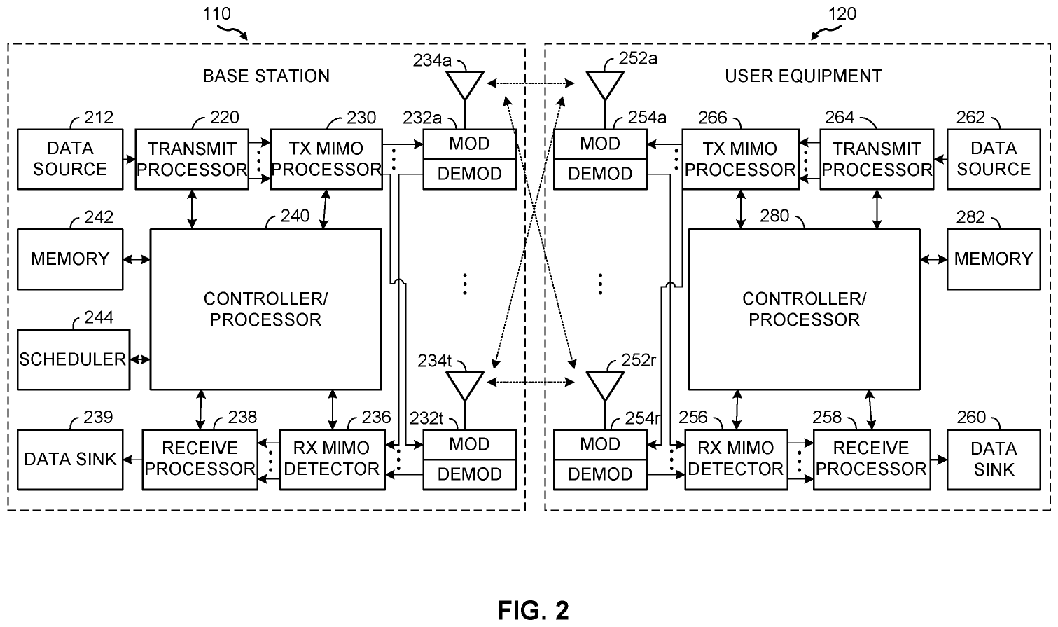

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the PUSCH) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIGS. 3A, 3B, 3C, and 3D depict aspects of data structures for a wireless communications network, such as wireless communications network 100 of FIG. 1, in accordance with the present disclosure. FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 3B and 3D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 3A and 3C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kilohertz (kHz), where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 3A, 3B, 3C, and 3D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 3A, some of the REs carry reference (pilot) signals (RSs) for a UE (e.g., UE 120). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 3B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 120) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 3C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

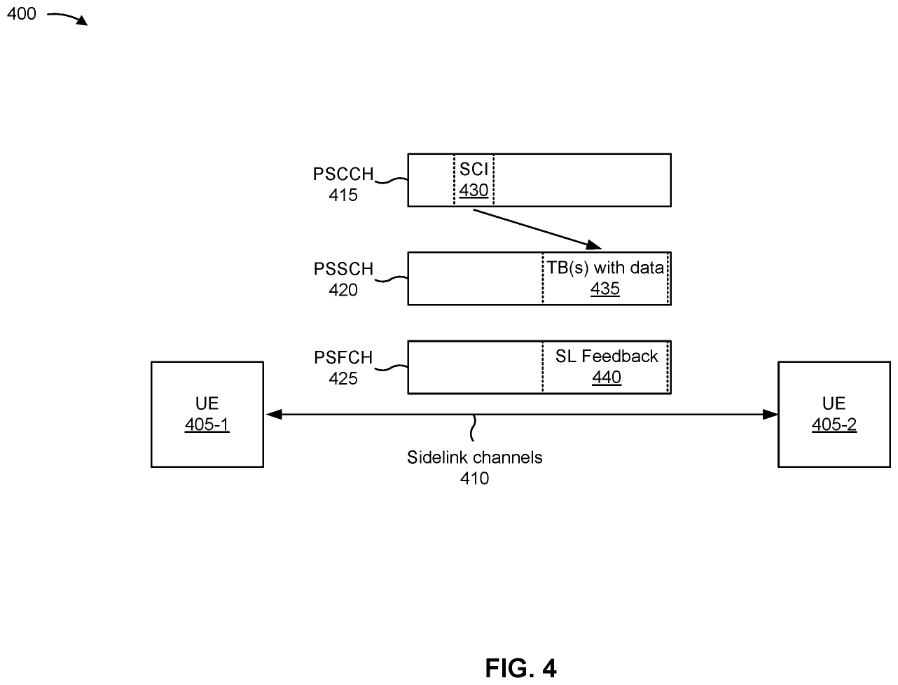

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band, such as a frequency band above 6 GHz (e.g., a frequency band in frequency range 2 (FR2)). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

In some aspects, the techniques and apparatuses described herein associated with AGC training for sidelink communications may be applied to sidelink communications as described with respect to FIG. 4.

As indicated above, FIG. 4 is provided as an example. Other examples may differ from what is described with respect to FIG. 4.

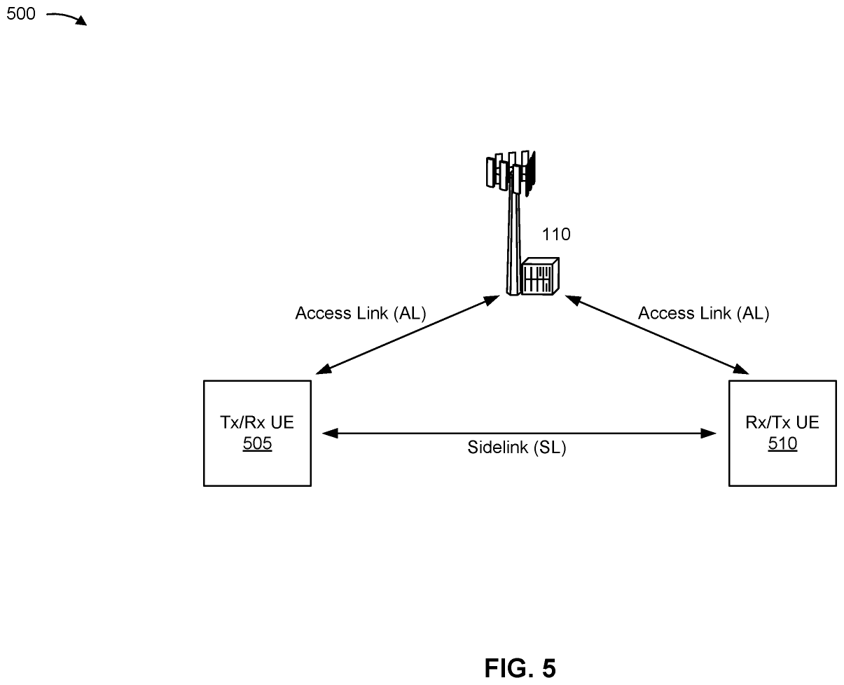

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In some aspects, the techniques and apparatuses described herein associated with AGC training for sidelink communications may be applied to sidelink communications as described with respect to FIG. 5.

As indicated above, FIG. 5 is provided as an example. Other examples may differ from what is described with respect to FIG. 5.

As described above, two or more wireless communication devices (e.g., UEs 120, UEs 405, a Tx/Rx UE 505 and an Rx/Tx UE 510, or the like) may in some wireless communication systems communicate with each other on a sidelink. Notably, there can be significant variation in one or more signal characteristics (e.g., signal power, noise, interference, or the like) on a sidelink over time. For example, the one or more signal characteristics may vary from one slot to the next or from one transmission to the next.

In some systems, automatic gain control (AGC) can be implemented to address the issue of varying signal characteristics in sidelink communications. For example, a receiver wireless communication device may perform AGC for reception of a sidelink communication transmitted by a transmitter wireless communication device. In one example, the receiver wireless communication device may regulate a received signal strength of the sidelink communication by performing outer loop AGC on the sidelink communication after a radio frequency (RF) chain of the receiver wireless communication device and prior to the sidelink communication being provided to an analog-to-digital converter (ADC) for analog-to-digital conversion. The outer loop AGC may include a closed feedback loop that measures a signal strength of the sidelink communication after analog-to-digital conversion, and modifies the RF gain parameter based at least in part on the measurement. If the signal strength is weak (e.g., is below a low threshold), then the outer loop AGC may modify the RF gain parameter to boost one or more receiver gain stages in the RF chain to reduce noise and improve the signal-to-noise ratio (SNR) of the sidelink communication. Conversely, if the signal strength of the sidelink communication is strong (e.g., is above a high threshold), then the outer loop AGC may modify the RF gain parameter to attenuate the one or more receiver gain stages in the RF chain to reduce signal clipping and/or nonlinear degradations of the sidelink communication.

A receiver wireless communication device may perform AGC training in association with performing AGC. Generally, AGC training is performed because the receiver wireless communication device needs to tune one or more receive chain components (e.g., a power amplifier (PA)) for reception of a given sidelink communication in order to properly set the gain based on the receive signal strength (e.g., so that AGC can be performed for reception of the sidelink communication). An AGC settling time is defined as an amount of time needed for the RF front end to perform a measurement and achieve convergence on the AGC loop so that an estimated gain for the one or more receive chain components (e.g., the PA) is within a desired accuracy. Notably, when the receiver wireless communication device does not perform AGC training before attempting to receive a sidelink communication or takes too much time to perform AGC training, one or more symbols of the sidelink communication may not be received correctly, potentially leading to loss of sidelink data.

Further, some wireless communication devices may be configured for sidelink communication in a higher frequency range, such as in a frequency band within FR2 (e.g., FR2-2). For sidelink communications in such higher frequency ranges, some wireless communication devices may be configured to utilize a higher subcarrier spacing (SCS), such as 120 kHz, 480 kHz, 960 kHz, or the like. In some wireless communication device implementations, in association with receiving a sidelink communication, a fast Fourier transform (FFT) length scales proportionally with increasing SCS but a sampling rate remains relatively constant regardless of SCS. That is, a sampling rate stays relatively constant regardless of numerology employed. An AGC settling time is related to a number of samples that can be obtained within a certain period of time. Thus, the same sampling rate may be used across different numerologies (e.g., even at higher SCSs), which means that an AGC settling time is constrained by the sampling rate. As one example, for some implementations, the AGC settling time is approximately 28.5 microseconds (μs) irrespective of SCS. Translating this AGC settling time to a quantity of symbols means that 4 AGC symbols are needed for an SCS of 120 kHz, 14 AGC symbols (e.g., one AGC slot) are needed for an SCS of 480 kHz, and 28 AGC symbols (e.g., two AGC slots) are needed for an SCS of 960 kHz (e.g., as compared to 1 AGC symbol being needed for an SCS of 30 kHz and 2 AGC symbols being needed for an SCS of 60 kHz). Thus, the quantity of symbols needed for AGC training increases with SCS.

A waveform for the multiple AGC symbols needs to be defined to support AGC training for sidelink communications in such higher frequency ranges (e.g., FR2-2). Further, an amount of overhead increases as the number of AGC symbols increases, which lowers throughput of sidelink communications. Therefore, it is desirable to reduce overhead associated with AGC symbol transmission, while maintaining support for AGC training for sidelink communications in higher frequency ranges.

Some aspects described herein provide techniques and apparatuses for AGC training for sidelink communications (e.g., sidelink communications in a higher frequency range, such as FR2-2). In some aspects, a transmitter wireless communication device may transmit a plurality of AGC symbols associated with one or more sidelink communications, and may transmit the one or more sidelink communications after transmitting the plurality of AGC symbols. In some aspects, an SCS of the plurality of AGC symbols and of symbols of the one or more sidelink communications is at least 120 kHz. In some aspects, the techniques and apparatuses described herein define a waveform for AGC symbols to be used for AGC training for sidelink communications and reduce overhead associated with transmission of the AGC symbols, thereby enabling reliable AGC training and increasing sidelink throughput. Additional details are provided below.

In some aspects, the plurality of AGC symbols includes a repetition of one or more symbols of the one or more sidelink communications. In some aspects, repetition of one or more symbols of the one or more sidelink communications does not increase complexity and consumption of resources (e.g., battery power, processor resources) in association with transmitting the plurality of AGC symbols. For example, because the plurality of AGC symbols includes repetitions of one or more symbols already generated by the transmitter wireless communication device, the transmitter wireless communication device does need not to generate any additional AGC symbols. Therefore, complexity and resource consumption at the transmitter wireless communication device are not increased.

In some aspects, the plurality of AGC symbols includes a plurality of randomly generated symbols. In some aspects, the use of a plurality of randomly generated symbols enables transmission of the plurality of AGC symbols irrespective of timing of generation of symbols of the one or more sidelink communications. That is, because the plurality of AGC symbols does not depend on symbols of the one or more sidelink communications when randomly generated symbols are used, the symbols of the one or more sidelink communications need not be ready for transmission at the time of transmission of the plurality of AGC symbols. Thus, late-arriving packets associated with the one or more sidelink communications do not impact transmission of the plurality of AGC symbols.

In some aspects, the plurality of AGC symbols includes a repetition of a DMRS associated with the one or more sidelink communications. In some aspects, the use of the DMRS enables transmission of the plurality of AGC symbols irrespective of timing of generation of symbols of the one or more sidelink communications. That is, because the plurality of AGC symbols does not depend on symbols of the one or more sidelink communications when the DMRS is used, the symbols of the one or more sidelink communications need not be ready at the time of transmission of the plurality of AGC symbols. Thus, late-arriving packets associated with the one or more sidelink communications do not impact transmission of the plurality of AGC symbols.

In some aspects, the one or more sidelink communications are transmitted in a plurality of contiguous slots (e.g., in a “super-slot) and the plurality of AGC symbols are transmitted in one or more slots immediately prior to the plurality of contiguous slots. In such an aspect, the plurality of AGC symbols can be utilized in association with performing AGC for each of the one or more sidelink communications in the plurality of contiguous slots (e.g., rather than for a single sidelink communication in a single slot). In this way, AGC overhead is reduced, thereby increasing throughput for sidelink communications.

Further, in some aspects, a receiver wireless communication device may determine and store a beam-specific AGC setting for a receive beam associated with reception of sidelink communications on a sidelink between the receiver wireless communication device and a transmitter wireless communication device. The receiver wireless communication device may then perform AGC for a sidelink communication received using the receive beam based at least in part on the beam-specific AGC setting. In some aspects, use of the stored beam-specific AGC setting may enable AGC for multiple sidelink communications using the receive beam without a need to repeat AGC training, thereby reducing AGC overhead and increasing throughput for sidelink communications.

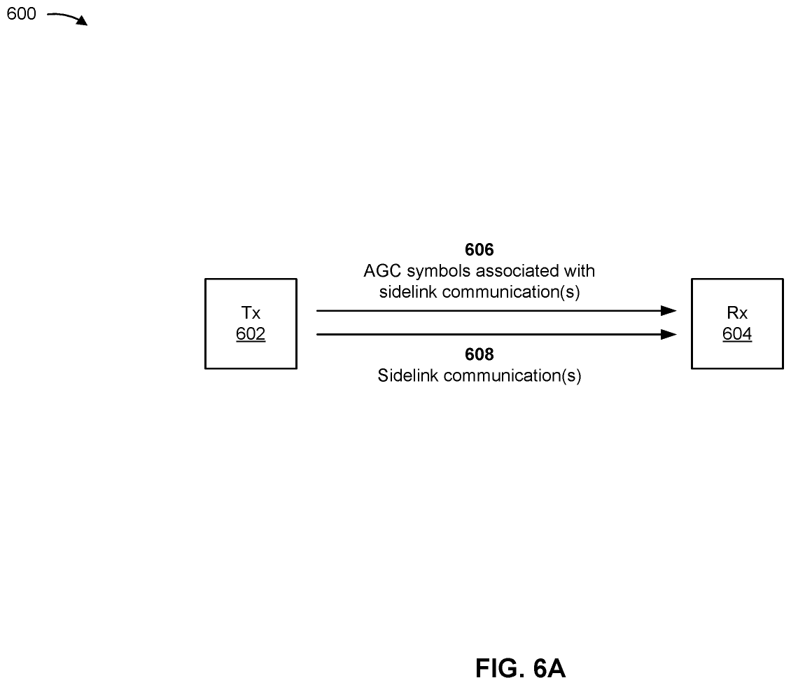

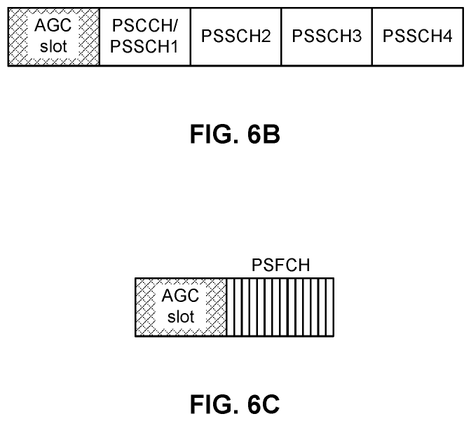

FIGS. 6A-6C are diagrams illustrating examples associated with AGC training for sidelink communications as described herein. As shown in FIG. 6A, an example 600 includes communication between a transmitter wireless communication device (Tx) 602 and a receiver wireless communication device (Rx) 604. In some aspects, the transmitter wireless communication device 602 and the receiver wireless communication device 604 may be included in a wireless network, such as a wireless network 100. In some aspects, the transmitter wireless communication device 602 may correspond to a UE 120, a UE 405, a Tx/Rx UE 505, or another wireless communication device described herein. In some aspects, the receiver wireless communication device 604 may correspond to a UE 120, a UE 405, an Rx/Tx UE 510, or another wireless communication device described herein. The transmitter wireless communication device 602 and the receiver wireless communication device 604 may communicate via a sidelink (e.g., via a PC5 interface).

As shown in FIG. 6A by reference 606, the transmitter wireless communication device 602 may transmit, and the receiver wireless communication device 604 may receive, a plurality of AGC symbols associated with one or more sidelink communications. The plurality of AGC symbols is a group of symbols for use in performing AGC for the one or more sidelink communications. That is, the plurality of AGC symbols includes multiple symbols that, upon receipt by the receiver wireless communication device 604, can be used to perform AGC for reception of one or more sidelink communications to be transmitted by the transmitter wireless communication device 602 for reception by the receiver wireless communication device 604.

In some aspects, an SCS of the plurality of AGC symbols and an SCS of symbols of the one or more sidelink communications are at least 120 kHz. That is, the plurality of AGC symbols and of symbols of the one or more sidelink communications may have a relatively high SCS. In some aspects, the plurality of AGC symbols and the symbols of the one or more sidelink communications may be transmitted in a high frequency band, such as an FR2 frequency band (e.g., a frequency band in FR2-2).

In some aspects, the plurality of AGC symbols includes one or more repetitions of a symbol of the one or more sidelink communications. That is, the plurality of AGC symbols may include N (N>1) symbols, where each of the N symbols is a repetition of a particular symbol of the following one or more sidelink communications. In some aspects, the symbol of the one or more sidelink communications that is used as the N AGC symbols may be a first (e.g., first in the time-domain) symbol of the one or more sidelink communications. As one illustrative example, the plurality of AGC symbols may include four symbols, where a first (in-time) AGC symbol is a repetition first (in-time) symbol of a sidelink communication, a second (in-time) AGC symbol is a repetition the first symbol of the sidelink communication, a third (in-time) AGC symbol is a repetition the first symbol of the sidelink communication, and a fourth (in-time) AGC symbol is a repetition the first symbol of the sidelink communication. In some aspects, repetition of the symbol (e.g., the first symbol) of the one or more sidelink communications prevents an increase in complexity and resource consumption (e.g., battery power, processor resources) in association with transmitting the plurality of AGC symbols. For example, because the plurality of AGC symbols include repetitions of a symbol that already needs to be generated by the transmitter wireless communication device 602, the transmitter wireless communication device 602 does need not to generate any symbols in addition to the symbols of the one or more sidelink communications. Therefore, complexity and resource consumption at the transmitter wireless communication device 602 are not increased.

In some aspects, the plurality of AGC symbols includes a repetition of a plurality of symbols of the one or more sidelink communications, where each AGC symbol of the plurality of AGC symbols corresponds to a respective symbol from the plurality of symbols of the one or more sidelink communications. That is, the plurality of AGC symbols may include N symbols, with the N symbols being a repetition of a particular group of N symbols of the following one or more sidelink communications. In some aspects, the N symbols of the one or more sidelink communications that are used as the N AGC symbols may be a first (e.g., first in the time-domain) N symbols of the one or more sidelink communications. As one illustrative example, the plurality of AGC symbols may include four symbols, where a first (in-time) AGC symbol is a repetition first (in-time) symbol of a sidelink communication, a second (in-time) AGC symbol is a repetition second (in-time) symbol of the sidelink communication, a third (in-time) AGC symbol is a repetition third (in-time) symbol of the sidelink communication, and a fourth (in-time) AGC symbol is a repetition fourth (in-time) symbol of the sidelink communication. In some such aspects, if the quantity of symbols in the plurality of AGC symbols is greater than the quantity of symbols in the one or more sidelink communications, then the plurality of AGC symbols may include one or more repetitions of a symbol (e.g., the first symbol) of the one or more sidelink communications. That is, if N is greater than the quantity of symbols in the one or more sidelink communications, then the plurality of AGC symbols may include a repetition of each symbol of the one or more sidelink communications and one or more additional repetitions of a particular symbol of the one or more sidelink communications. In some aspects, repetition of the plurality of symbols (e.g., the first N symbols) of the one or more sidelink communications prevents an increase in complexity and resource consumption (e.g., battery power, processor resources) in association with transmitting the plurality of AGC symbols. For example, because the plurality of AGC symbols includes repetitions of symbols that already need to be generated by the transmitter wireless communication device 602, the transmitter wireless communication device 602 does need not to generate any symbols in addition to the symbols of the one or more sidelink communications. Therefore, complexity and resource consumption at the transmitter wireless communication device 602 are not increased.

In some aspects, the transmitter wireless communication device 602 may generate the plurality of AGC symbols. For example, in some aspects, the transmitter wireless communication device 602 may generate the plurality of AGC symbols based at least in part on a quadrature phase shift keying (QPSK) sequence. That is, the transmitter wireless communication device 602 may (randomly) generate a QPSK sequence, apply an inverse FFT and a cyclic prefix (CP), and use a result as the plurality of AGC symbols. As another example, the transmitter wireless communication device 602 may generate the plurality of AGC symbols based at least in part on a quadrature amplitude modulation (QAM) sequence. That is, the transmitter wireless communication device 602 may (randomly) generate a QAM sequence with a modulation order that matches a modulation order of the one or more sidelink communications, and may use a result as the plurality of AGC symbols. In some aspects, the transmitter wireless communication device 602 may generate the plurality of AGC symbols based at least in part on one or more parameters (e.g., a precoding parameter, a beamforming parameter, or the like) that match a corresponding one or more parameters applied in association with generating symbols of the one or more sidelink communications. In some aspects, the use of a plurality of randomly generated symbols enables transmission of the plurality of AGC symbols irrespective of timing of generation of symbols of the one or more sidelink communications. That is, because the plurality of AGC symbols does not depend on symbols of the one or more sidelink communications when randomly generated symbols are used, the symbols of the one or more sidelink communications need not be ready for transmission at the time of transmission of the plurality of AGC symbols. Thus, late-arriving packets associated with the one or more sidelink communications do not impact transmission of the plurality of AGC symbols.

In some aspects, the plurality of AGC symbols includes a repetition of a DMRS associated with the one or more sidelink communications. That is, in some aspects, the transmitter wireless communication device 602 may use the DMRS of the one or more sidelink communications as the plurality of AGC symbols. As one example, for a PUCCH format 0 (PF0) PSFCH communication, the transmitter wireless communication device 602 may use a length-12 computer generated sequence in the PSFCH as the plurality of AGC symbols. As another example, for a PSCCH communication or a PSSCH communication, the transmitter wireless communication device 602 may repeat a DMRS and copy the DMRS to the AGC symbols. In some aspects, the use of the DMRS enables transmission of the plurality of AGC symbols irrespective of timing of generation of symbols of the one or more sidelink communications. That is, because the plurality of AGC symbols does not depend on symbols of the one or more sidelink communications when the DMRS is used as the plurality of AGC symbols, the symbols of the one or more sidelink communications need not be ready at the time of transmission of the plurality of AGC symbols. Thus, late-arriving packets associated with the one or more sidelink communications do not impact transmission of the plurality of AGC symbols.

As shown by reference 608, after transmitting the plurality of AGC symbols, the transmitter wireless communication device 602 may transmit, and the receiver wireless communication device 604 may receive, the one or more sidelink communications.

In some aspects, the one or more sidelink communications may include one or more PSCCH communications or one or more PSSCH communications. In some such aspects, the one or more PSCCH communications or the one or more PSSCH communications are transmitted in a plurality of contiguous slots (sometimes referred to as a super-slot) and the plurality of AGC symbols are transmitted in one or more slots immediately prior to the plurality of contiguous slots. FIG. 6B is a diagram illustrating an example of a transmission of a plurality of AGC symbols immediately prior to a plurality of contiguous slots. In the example shown in FIG. 6B, the plurality of AGC symbols comprises a slot of AGC symbols (e.g., 14 AGC symbols). As shown, the AGC slot is transmitted immediately prior to a plurality of contiguous slots in which a PSCCH communication and four PSSCH communications are transmitted. In some aspects, the plurality of contiguous slots is associated with a single receiver wireless communication device 604. In such an aspect, the receiver wireless communication device 604 can perform AGC training at a start of the plurality of contiguous slots only (e.g., rather than prior to each slot), and a result of the AGC training can be applied to reception of a sidelink communication in each of the plurality of contiguous slots. Here, because transmission in the high frequency range of operation (e.g., FR2-2) is directional, a likelihood that the receiver wireless communication device 604 receives other sidelink communications during the plurality of contiguous slots with the same receive beam is negligible.

Additionally, or alternatively, the one or more one or more sidelink communications include one or more PSFCH communications. In some such aspects, the one or more PSFCH communications are transmitted in a single slot and the plurality of AGC symbols are transmitted in one or more slots immediately prior to the single slot. FIG. 6C is a diagram illustrating an example of a transmission of a plurality of AGC symbols immediately prior to a slot comprising multiple PSFCH communications. In the example shown in FIG. 6C, the plurality of AGC symbols comprises a slot of AGC symbols (e.g., 14 AGC symbols). As shown, the AGC slot is transmitted immediately prior to a slot in which a plurality of PSFCH communications are transmitted. In this way, multiple PSFCH symbols (e.g., each mapped to a different PSSCH slot) can be grouped into a single slot and can share the plurality of AGC symbols.

In an aspect in which the plurality of AGC symbols is transmitted prior to a plurality of sidelink communications (e.g., a super-slot of PSCCH/PSSCH communications, a single slot of multiple PSFCH communications), the plurality of AGC symbols can be utilized in association with performing AGC for each of the one or more sidelink communications. In this way, AGC overhead is reduced, thereby increasing throughput for sidelink communications.

As indicated above, FIGS. 6A-6C are provided as examples. Other examples may differ from what is described with respect to FIGS. 6A-6C.

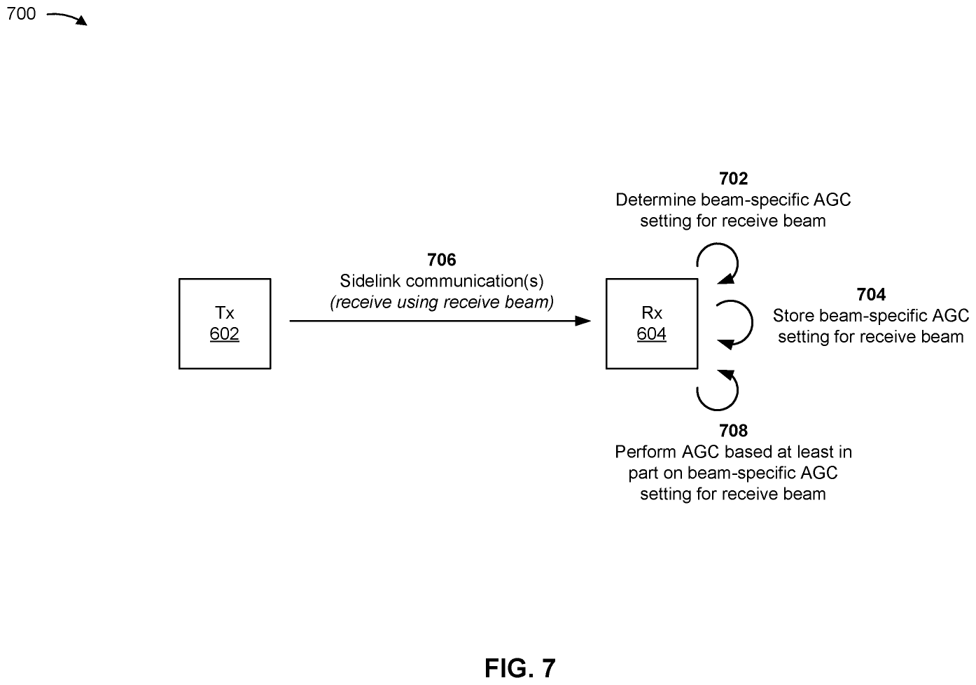

FIG. 7 is a diagram illustrating an example 700 associated with AGC training for sidelink communications as described herein. As shown in FIG. 7, the example 700 includes communication between a transmitter wireless communication device (Tx) 602 and a receiver wireless communication device (Rx) 604. In some aspects, the transmitter wireless communication device 602 and the receiver wireless communication device 604 may be included in a wireless network, such as a wireless network 100. The transmitter wireless communication device 602 and the receiver wireless communication device 604 may communicate via a sidelink (e.g., via a PC5 interface).

In some higher frequency ranges, such as within FR2-2, the transmitter wireless communication device 602 and the receiver wireless communication device 604 may utilize relative (spatially) narrow beams for communication on the sidelink. Thus, a receive beam used by the receiver wireless communication device 604 may be well-suited to receive signals from the transmitter wireless communication device 602 without receiving signals from other transmitter devices (e.g., other transmitter wireless communication devices 602). Thus, by utilizing beam management and in a low mobility scenario, the receive beam would remain pointed to the same transmitter wireless communication device 602 if the sidelink between the transmitter wireless communication device 602 and the receiver wireless communication device 604 is maintained. In such a scenario, the receiver wireless communication device 604 may be capable of maintaining a beam-specific AGC setting associated with the receive beam that can be used over time (e.g., without a need for additional AGC training).

In some aspects, as shown by reference 702, the receiver wireless communication device 604 may determine the beam-specific AGC setting for the receive beam associated with reception of sidelink communications on the sidelink between the receiver wireless communication device 604 and the transmitter wireless communication device 602. A beam-specific AGC setting is a parameter based at least in part on which the receiver wireless communication device 604 may perform AGC for a sidelink communication received using a specific receive beam. That is, the beam-specific AGC setting is particular to the specific receive beam. In some aspects, the receiver wireless communication device 604 may determine the beam-specific AGC setting at an initial phase of establishing the sidelink and beam pairing.

In some aspects, to determine the beam-specific AGC setting, the receiver wireless communication device 604 may receive a plurality of AGC symbols on the sidelink using the receive beam, and may determine the beam-specific AGC setting based at least in part on the plurality of AGC symbols. For example, the transmitter wireless communication device 602 may transmit a plurality of AGC symbols (e.g., in the manner described above with respect to FIGS. 6A-6C). Here, the receiver wireless communication device 604 may receive the plurality of AGC symbols and may perform AGC training, a result of which provides the beam-specific AGC setting. In some aspects, further transmission/reception of AGC symbols may cease (e.g., the transmitter wireless communication device 602 may refrain from transmitting further AGC symbols), thereby reducing overhead and increasing sidelink throughput.

Additionally, or alternatively, to determine the beam-specific AGC setting, the receiver wireless communication device 604 may receive an initial sidelink communication on the sidelink using the receive beam, and may determine the beam-specific AGC setting based at least in part on the initial sidelink communication. Notably, in such an aspect, no AGC symbols are transmitted, thereby reducing overhead and increasing sidelink throughput, even for the initial sidelink communication. In some aspects, for reception of the initial sidelink communication, the receiver wireless communication device 604 may be configured to use a default (e.g., conservative) AGC setting and the initial sidelink communication may use a lower modulation order or code rate (e.g., to improve a likelihood that the initial sidelink communication is successfully decoded).

As shown by reference 704, the receiver wireless communication device 604 may store an indication of the beam-specific AGC setting for the receive beam. That is, the receiver wireless communication device 604 may store the beam-specific AGC setting (e.g., such that the receiver wireless communication device 604 can determine the beam-specific AGC setting at a later time). In some aspects, the receiver wireless communication device 604 may store beam-specific AGC settings for multiple receive beams in the manner described above.

As shown by reference 706, the transmitter wireless communication device 602 may transmit, and the receiver wireless communication device 604 may receive, a sidelink communication on the sidelink using the receive beam.

As shown by reference 708, the receiver wireless communication device 604 may perform AGC for the sidelink communication based at least in part on the beam-specific AGC setting. For example, the receiver wireless communication device 604 may determine the stored beam-specific AGC setting associated with the receive beam, and may utilize the beam-specific AGC setting in association with performing AGC for the sidelink communication received using the receive beam.

In some aspects, if the receive beam associated with the sidelink between the transmitter wireless communication device 602 and the receiver wireless communication device 604 changes (e.g., from a first receive beam to a second receive beam), then additional AGC training may be needed. In some such aspects, the receiver wireless communication device 604 may transmit a request to cause the transmitter wireless communication device 602 to transmit a plurality of AGC symbols (e.g., based at least in part on a determination that the second receive beam is to be used for receiving sidelink communications on the sidelink). The transmitter wireless communication device 602 may receive the request and may transmit the plurality of AGC symbols, and the receiver wireless communication device 604 may determine and store a beam-specific AGC associated with the second receive beam accordingly.

As indicated above, FIG. 7 is provided as an example. Other examples may differ from what is described with respect to FIG. 7.

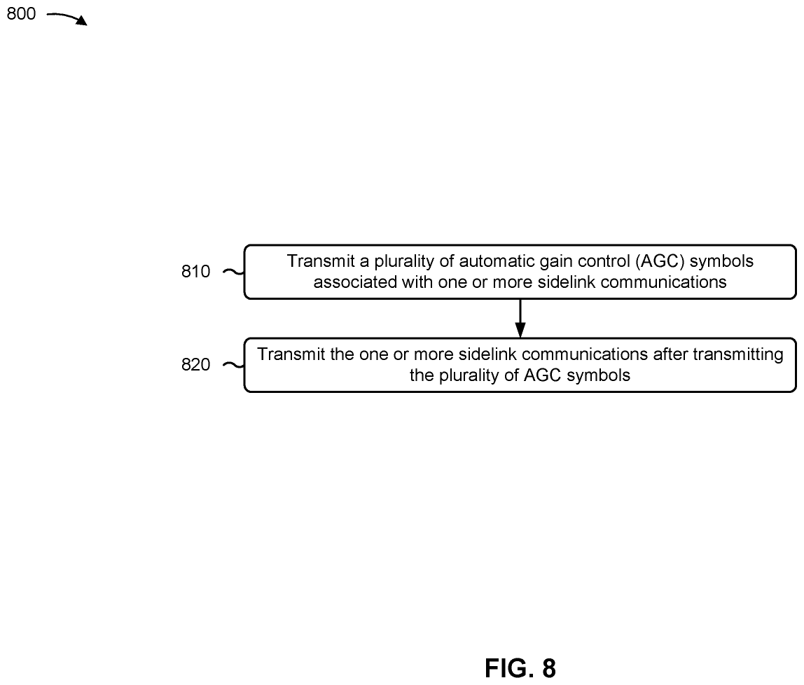

FIG. 8 shows a method 800 for wireless communications by an apparatus, such as transmitter wireless communication device 402 or a UE 120.

Method 800 begins at 810 with transmitting a plurality of AGC symbols associated with one or more sidelink communications.

Method 800 then proceeds to step 820 with transmitting the one or more sidelink communications after transmitting the plurality of AGC symbols.

In a first aspect, an SCS of the plurality of AGC symbols and an SCS of symbols of the one or more sidelink communications are at least 120 kHz.

In a second aspect, the plurality of AGC symbols includes one or more repetitions of a symbol of the one or more sidelink communications.

In a third aspect, the plurality of AGC symbols includes a repetition of a plurality of symbols of the one or more sidelink communications, each AGC symbol of the plurality of AGC symbols corresponding to a respective symbol from the plurality of symbols of the one or more sidelink communications.

In a fourth aspect, the plurality of AGC symbols includes one or more repetitions of a symbol of the one or more sidelink communications.

In a fifth aspect, method 800 includes generating the plurality of AGC symbols based at least in part on a QPSK sequence.

In a sixth aspect, method 800 includes generating the plurality of AGC symbols based at least in part on a QAM sequence, the QAM sequence having a modulation order that matches a modulation order of the one or more sidelink communications.

In a seventh aspect, method 800 includes generating the plurality of AGC symbols based at least in part on one or more parameters, wherein the one or more parameters match (e.g., are the same as) a corresponding one or more parameters applied in association with generating symbols of the one or more sidelink communications.

In an eighth aspect, the plurality of AGC symbols includes a repetition of a DMRS associated with the one or more sidelink communications.

In a ninth aspect, the one or more sidelink communications include one or more PSCCH communications or one or more PSSCH communications.

In a tenth aspect, the one or more PSCCH communications or the one or more PSSCH communications are transmitted in a plurality of contiguous slots and the plurality of AGC symbols are transmitted in one or more slots immediately prior to the plurality of contiguous slots.

In an eleventh aspect, the one or more sidelink communications include one or more PSFCH communications.

In a twelfth aspect, the one or more PSFCH communications are transmitted in a single slot and the plurality of AGC symbols are transmitted in one or more slots immediately prior to the single slot.

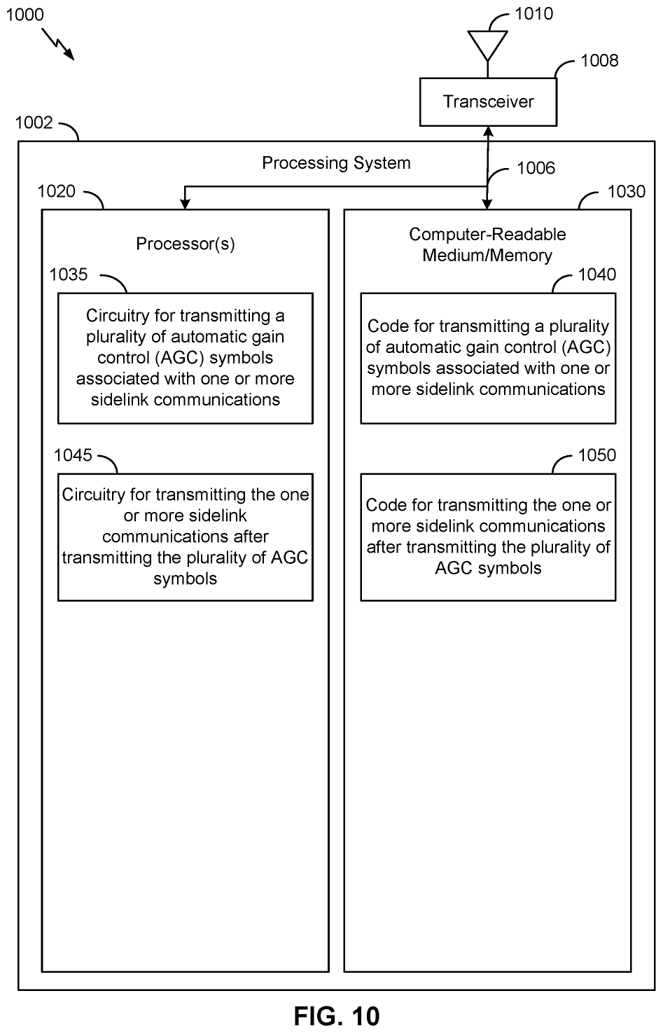

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

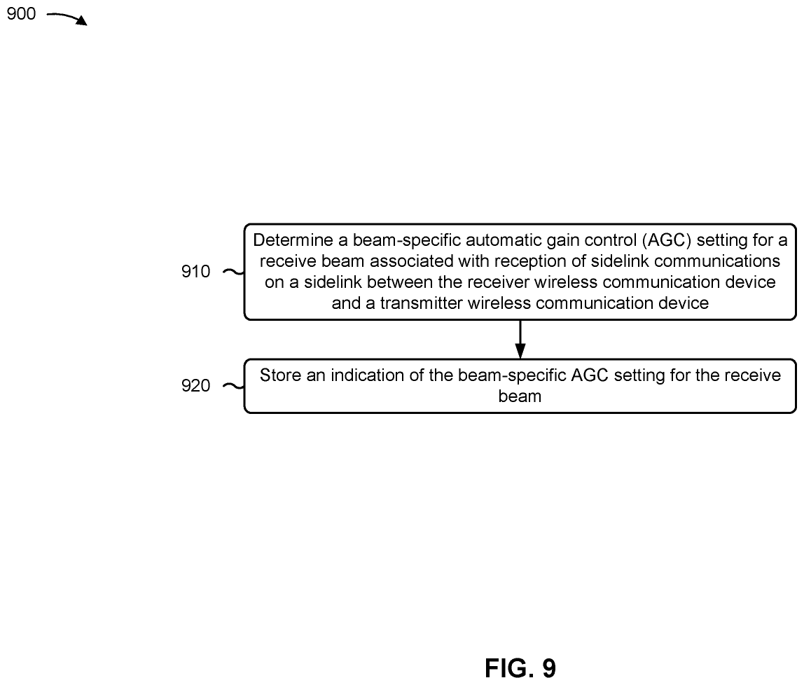

FIG. 9 shows a method 900 for wireless communications by an apparatus, such as a receiver wireless communication device 404 or a UE 120.

Method 900 begins at 910 with determining a beam-specific AGC setting for a receive beam associated with reception of sidelink communications on a sidelink between the apparatus and a transmitter wireless communication device.

Method 900 then proceeds to step 920 with storing an indication of the beam-specific AGC setting for the receive beam.

In a first aspect, method 900 includes receiving a sidelink communication on the sidelink using the receive beam, and performing AGC for the sidelink communication based at least in part on the beam-specific AGC setting.

In a second aspect, determining the beam-specific AGC setting comprises receiving a plurality of AGC symbols on the sidelink using the receive beam, and determining the beam-specific AGC setting based at least in part on the plurality of AGC symbols.

In a third aspect, the receive beam is a first receive beam, the plurality of AGC symbols is a first plurality of AGC symbols, and the method further comprises transmitting a request to cause the transmitter wireless communication device to transmit a second plurality of AGC symbols based at least in part on a determination that a second receive beam is to be used for receiving sidelink communications on the sidelink.

In a fourth aspect, determining the beam-specific AGC setting comprises receiving an initial sidelink communication on the sidelink using the receive beam, and determining the beam-specific AGC setting based at least in part on the initial sidelink communication.

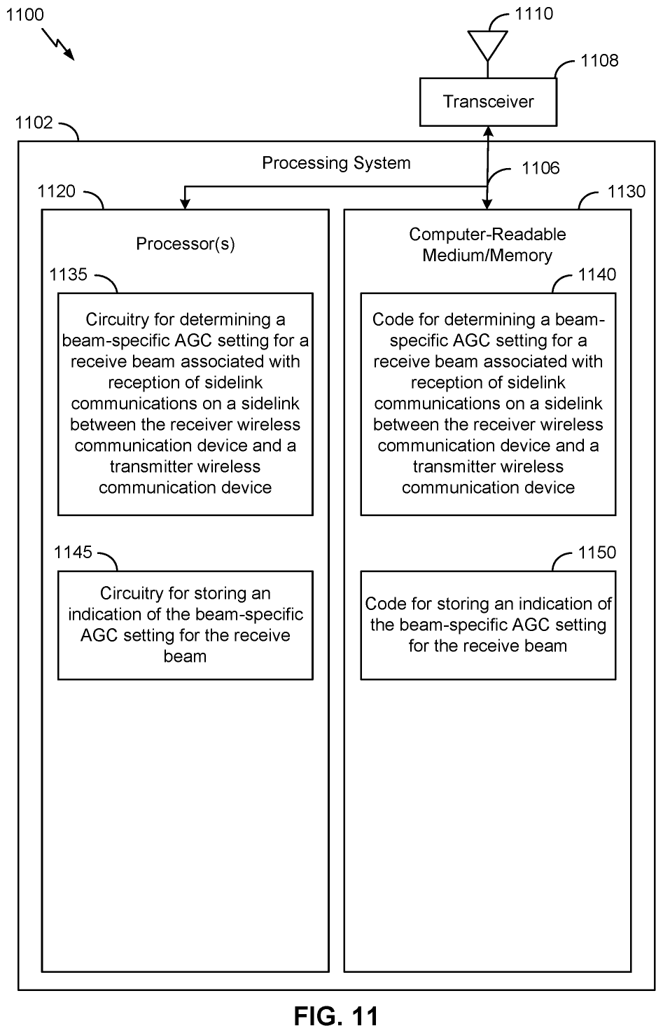

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

FIG. 10 is a diagram illustrating an example of an implementation of code and circuitry for a communications device 1000, in accordance with the present disclosure. The communications device 1000 may be a transmitter wireless communication device, or a transmitter wireless communication device may include the communications device 1000.

The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes one or more processors 1020. In various aspects, the one or more processors 1020 may be representative of one or more of receive processor 258, transmit processor 264, TX MIMO processor 266, and/or controller/processor 280, as described with respect to FIG. 2. The one or more processors 1020 are coupled to a computer-readable medium/memory 1030 via a bus 1006. In various aspects, the computer-readable medium/memory 1030 may be representative of memory 282, as described with respect to FIG. 2. In certain aspects, the computer-readable medium/memory 1030 is configured to store instructions (e.g., computer-executable code, processor-executable code) that when executed by the one or more processors 1020, cause the one or more processors 1020 to perform the method 800 described with respect to FIG. 8, or any aspect related to it. Note that reference to a processor performing a function of communications device 1000 may include one or more processors performing that function of communications device 1000.

As shown in FIG. 10, the communications device 1000 may include circuitry for transmitting a plurality of AGC symbols associated with one or more sidelink communications (circuitry 1035).

As shown in FIG. 10, the communications device 1000 may include, stored in computer-readable medium/memory 1030, code for transmitting a plurality of AGC symbols associated with one or more sidelink communications (code 1040).

As shown in FIG. 10, the communications device 1000 may include circuitry for transmitting the one or more sidelink communications after transmitting the plurality of AGC symbols (circuitry 1045).

As shown in FIG. 10, the communications device 1000 may include, stored in computer-readable medium/memory 1030, code for transmitting the one or more sidelink communications after transmitting the plurality of AGC symbols (code 1050).

Various components of the communications device 1000 may provide means for performing the method 800 described with respect to FIG. 8, or any aspect related to it. For example, means for transmitting, sending, or outputting for transmission may include the transceiver(s) 254 and/or antenna(s) 252 of the UE 120 and/or transceiver 1008 and antenna 1010 of the communications device 1000 in FIG. 10. Means for receiving or obtaining may include the transceiver(s) 254 and/or antenna(s) 252 of the UE 120 and/or transceiver 1008 and antenna 1010 of the communications device 1000 in FIG. 10.

FIG. 10 is provided as an example. Other examples may differ from what is described in connection with FIG. 10.

FIG. 11 is a diagram illustrating an example of an implementation of code and circuitry for a communications device 1100, in accordance with the present disclosure. The communications device 1100 may be a receiver wireless communication device, or a receiver wireless communication device may include the communications device 1100.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 258, transmit processor 264, TX MIMO processor 266, and/or controller/processor 280, as described with respect to FIG. 2. The one or more processors 1120 are coupled to a computer-readable medium/memory 1130 via a bus 1106. In various aspects, the computer-readable medium/memory 1130 may be representative of memory 282, as described with respect to FIG. 2. In certain aspects, the computer-readable medium/memory 1130 is configured to store instructions (e.g., computer-executable code, processor-executable code) that when executed by the one or more processors 1120, cause the one or more processors 1120 to perform the method 900 described with respect to FIG. 9, or any aspect related to it. Note that reference to a processor performing a function of communications device 1100 may include one or more processors performing that function of communications device 1100.

As shown in FIG. 11, the communications device 1100 may include circuitry for determining a beam-specific AGC setting for a receive beam associated with reception of sidelink communications on a sidelink between the receiver wireless communication device and a transmitter wireless communication device (circuitry 1135).

As shown in FIG. 11, the communications device 1100 may include, stored in computer-readable medium/memory 1130, code for determining a beam-specific AGC setting for a receive beam associated with reception of sidelink communications on a sidelink between the receiver wireless communication device and a transmitter wireless communication device (code 1140).

As shown in FIG. 11, the communications device 1100 may include circuitry for storing an indication of the beam-specific AGC setting for the receive beam (circuitry 1145).

As shown in FIG. 11, the communications device 1100 may include, stored in computer-readable medium/memory 1130, code for storing an indication of the beam-specific AGC setting for the receive beam (code 1150).

Various components of the communications device 1100 may provide means for performing the method 900 described with respect to FIG. 9, or any aspect related to it. For example, means for transmitting, sending, or outputting for transmission may include the transceiver(s) 254 and/or antenna(s) 252 of the UE 120 and/or transceiver 1108 and antenna 1110 of the communications device 1100 in FIG. 11. Means for receiving or obtaining may include the transceiver(s) 254 and/or antenna(s) 252 of the UE 120 and/or transceiver 1108 and antenna 1110 of the communications device 1100 in FIG. 11.

FIG. 11 is provided as an example. Other examples may differ from what is described in connection with FIG. 11.

The following provides an overview of some Aspects of the present disclosure:
Aspect 1: A method of wireless communications performed by a transmitter wireless communication device, comprising: transmitting a plurality of automatic gain control (AGC) symbols associated with one or more sidelink communications; and transmitting the one or more sidelink communications after transmitting the plurality of AGC symbols.
Aspect 2: The method of Aspect 1, wherein a subcarrier spacing (SCS) of the plurality of AGC symbols and an SCS of symbols of the one or more sidelink communications are at least 120 kilohertz (kHz).
Aspect 3: The method of any of Aspects 1-2, wherein the plurality of AGC symbols includes one or more repetitions of a symbol of the one or more sidelink communications.
Aspect 4: The method of any of Aspects 1-3, wherein the plurality of AGC symbols includes a repetition of a plurality of symbols of the one or more sidelink communications, each AGC symbol of the plurality of AGC symbols corresponding to a respective symbol from the plurality of symbols of the one or more sidelink communications.
Aspect 5: The method of Aspect 4, wherein the plurality of AGC symbols includes one or more repetitions of a symbol of the one or more sidelink communications.
Aspect 6: The method of any of Aspects 1-5, further comprising generating the plurality of AGC symbols based at least in part on a quadrature phase shift keying (QPSK) sequence.
Aspect 7: The method of any of Aspects 1-6, further comprising generating the plurality of AGC symbols based at least in part on a quadrature amplitude modulation (QAM) sequence, the QAM sequence having a modulation order that matches a modulation order of the one or more sidelink communications.
Aspect 8: The method of any of Aspects 1-7, further comprising generating the plurality of AGC symbols based at least in part on one or more parameters, wherein the one or more parameters match a corresponding one or more parameters applied in association with generating symbols of the one or more sidelink communications.
Aspect 9: The method of any of Aspects 1-8, wherein the plurality of AGC symbols includes a repetition of a demodulation reference signal (DMRS) associated with the one or more sidelink communications.
Aspect 10: The method of any of Aspects 1-9, wherein the one or more sidelink communications include one or more physical sidelink control channel (PSCCH) communications or one or more physical sidelink shared channel (PSSCH) communications.
Aspect 11: The method of Aspect 10, wherein the one or more PSCCH communications or the one or more PSSCH communications are transmitted in a plurality of contiguous slots and the plurality of AGC symbols are transmitted in one or more slots immediately prior to the plurality of contiguous slots.
Aspect 12: The method of any of Aspects 1-11, wherein the one or more sidelink communications include one or more physical sidelink feedback channel (PSFCH) communications.
Aspect 13: The method of Aspect 12, wherein the one or more PSFCH communications are transmitted in a single slot and the plurality of AGC symbols are transmitted in one or more slots immediately prior to the single slot.
Aspect 14: A method of wireless communications performed by a receiver wireless communication device, comprising: determining a beam-specific automatic gain control (AGC) setting for a receive beam associated with reception of sidelink communications on a sidelink between the receiver wireless communication device and a transmitter wireless communication device; and storing an indication of the beam-specific AGC setting for the receive beam.
Aspect 15: The method of Aspect 14, further comprising: receiving a sidelink communication on the sidelink using the receive beam; and performing AGC for the sidelink communication based at least in part on the beam-specific AGC setting.
Aspect 16: The method of any of Aspects 14-15, wherein determining the beam-specific AGC setting comprises: receiving a plurality of AGC symbols on the sidelink using the receive beam; and determining the beam-specific AGC setting based at least in part on the plurality of AGC symbols.
Aspect 17: The method of Aspect 16, wherein the receive beam is a first receive beam, the plurality of AGC symbols is a first plurality of AGC symbols, and the method further comprises: transmitting a request to cause the transmitter wireless communication device to transmit a second plurality of AGC symbols based at least in part on a determination that a second receive beam is to be used for receiving sidelink communications on the sidelink.
Aspect 18: The method of any of Aspects 14-17, wherein determining the beam-specific AGC setting comprises: receiving an initial sidelink communication on the sidelink using the receive beam; and determining the beam-specific AGC setting based at least in part on the initial sidelink communication.
Aspect 19: An apparatus for wireless communication at a device, comprising a processor; memory coupled with the processor; and instructions stored in the memory and executable by the processor to cause the apparatus to perform the method of one or more of Aspects 1-13.
Aspect 20: A device for wireless communication, comprising a memory and one or more processors coupled to the memory, the one or more processors configured to perform the method of one or more of Aspects 1-13.
Aspect 21: An apparatus for wireless communication, comprising at least one means for performing the method of one or more of Aspects 1-13.
Aspect 22: A non-transitory computer-readable medium storing code for wireless communication, the code comprising instructions executable by a processor to perform the method of one or more of Aspects 1-13.
Aspect 23: A non-transitory computer-readable medium storing a set of instructions for wireless communication, the set of instructions comprising one or more instructions that, when executed by one or more processors of a device, cause the device to perform the method of one or more of Aspects 1-13.
Aspect 24: An apparatus for wireless communication at a device, comprising a processor; memory coupled with the processor; and instructions stored in the memory and executable by the processor to cause the apparatus to perform the method of one or more of Aspects 14-18.
Aspect 25: A device for wireless communication, comprising a memory and one or more processors coupled to the memory, the one or more processors configured to perform the method of one or more of Aspects 14-18.
Aspect 26: An apparatus for wireless communication, comprising at least one means for performing the method of one or more of Aspects 14-18.
Aspect 27: A non-transitory computer-readable medium storing code for wireless communication, the code comprising instructions executable by a processor to perform the method of one or more of Aspects 14-18.
Aspect 28: A non-transitory computer-readable medium storing a set of instructions for wireless communication, the set of instructions comprising one or more instructions that, when executed by one or more processors of a device, cause the device to perform the method of one or more of Aspects 14-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories comprising processor-executable instructions; and one or more processors configured to execute the processor-executable instructions and cause the apparatus to:
transmit a plurality of automatic gain control (AGC) symbols associated with one or more sidelink communications; and
transmit the one or more sidelink communications after transmitting the plurality of AGC symbols.

2. The apparatus of claim 1, wherein a subcarrier spacing (SCS) of the plurality of AGC symbols and an SCS of symbols of the one or more sidelink communications are at least 120 kilohertz (kHz).

3. The apparatus of claim 1, wherein the plurality of AGC symbols includes one or more repetitions of a symbol of the one or more sidelink communications.

4. The apparatus of claim 1, wherein the plurality of AGC symbols includes a repetition of a plurality of symbols of the one or more sidelink communications, each AGC symbol of the plurality of AGC symbols corresponding to a respective symbol from the plurality of symbols of the one or more sidelink communications.

5. The apparatus of claim 4, wherein the plurality of AGC symbols includes one or more repetitions of a symbol of the one or more sidelink communications.

6. The apparatus of claim 1, wherein the processor is configured to execute the processor-executable instructions and further cause the apparatus to generate the plurality of AGC symbols based at least in part on a quadrature phase shift keying (QPSK) sequence.

7. The apparatus of claim 1, wherein the processor is configured to execute the processor-executable instructions and further cause the apparatus to generate the plurality of AGC symbols based at least in part on a quadrature amplitude modulation (QAM) sequence, the QAM sequence having a modulation order that matches a modulation order of the one or more sidelink communications.

8. The apparatus of claim 1, wherein the processor is configured to execute the processor-executable instructions and further cause the apparatus to generate the plurality of AGC symbols based at least in part on one or more parameters, wherein the one or more parameters match a corresponding one or more parameters applied in association with generating symbols of the one or more sidelink communications.

9. The apparatus of claim 1, wherein the plurality of AGC symbols includes a repetition of a demodulation reference signal (DMRS) associated with the one or more sidelink communications.

10. The apparatus of claim 1, wherein the one or more sidelink communications include one or more physical sidelink control channel (PSCCH) communications or one or more physical sidelink shared channel (PSSCH) communications.

11. The apparatus of claim 10, wherein the one or more PSCCH communications or the one or more PSSCH communications are transmitted in a plurality of contiguous slots and the plurality of AGC symbols are transmitted in one or more slots immediately prior to the plurality of contiguous slots.

12. The apparatus of claim 1, wherein the one or more sidelink communications include one or more physical sidelink feedback channel (PSFCH) communications.

13. The apparatus of claim 12, wherein the one or more PSFCH communications are transmitted in a single slot and the plurality of AGC symbols are transmitted in one or more slots immediately prior to the single slot.

14. An apparatus for wireless communication, comprising:
one or more memories comprising processor-executable instructions; and one or more processors configured to execute the processor-executable instructions and cause the apparatus to:
determine a beam-specific automatic gain control (AGC) setting for a receive beam associated with reception of sidelink communications on a sidelink between the apparatus and a transmitter wireless communication device; and
store an indication of the beam-specific AGC setting for the receive beam.

15. The apparatus of claim 14, wherein the processor is configured to execute the processor-executable instructions and further cause the apparatus to:
receive a sidelink communication on the sidelink using the receive beam; and
perform AGC for the sidelink communication based at least in part on the beam-specific AGC setting.

16. The apparatus of claim 14, wherein, to determine the beam-specific AGC setting, the processor is configured to execute the processor-executable instructions and cause the apparatus to:
receive a plurality of AGC symbols on the sidelink using the receive beam; and
determine the beam-specific AGC setting based at least in part on the plurality of AGC symbols.

17. The apparatus of claim 16, wherein the receive beam is a first receive beam, the plurality of AGC symbols is a first plurality of AGC symbols, and the processor is configured to execute the processor-executable instructions and further cause the apparatus to:
transmit a request to cause the transmitter wireless communication device to transmit a second plurality of AGC symbols based at least in part on a determination that a second receive beam is to be used for receiving sidelink communications on the sidelink.

18. The apparatus of claim 14, wherein, to determine the beam-specific AGC setting, the processor is configured to execute the processor-executable instructions and cause the apparatus to:
receive an initial sidelink communication on the sidelink using the receive beam; and
determine the beam-specific AGC setting based at least in part on the initial sidelink communication.

20. A method of wireless communication performed by a transmitter wireless communication device, comprising:
transmitting a plurality of automatic gain control (AGC) symbols associated with one or more sidelink communications; and
transmitting the one or more sidelink communications after transmitting the plurality of AGC symbols.

21. A method of wireless communication performed by a receiver wireless communication device, comprising:
determining a beam-specific automatic gain control (AGC) setting for a receive beam associated with reception of sidelink communications on a sidelink between the receiver wireless communication device and a transmitter wireless communication device; and
storing an indication of the beam-specific AGC setting for the receive beam.
